(19) United States
(12) Patent Application Publication
(10) Pub. No.: US 2025/0303835 A1
(43) Pub. Date: Oct. 2, 2025

(54) SUNROOF DEVICE

(71) Applicant: AISIN CORPORATION, Kariya-shi (JP)

(72) Inventor: Ryuto YANAGITANI, Kariya-shi (JP)

(73) Assignee: AISIN CORPORATION, Kariya-shi (JP)

(21) Appl. No.: 19/089,619

(22) Filed: Mar. 25, 2025

(30) Foreign Application Priority Data
Mar. 28, 2024 (JP) 2024-054691
Jan. 17, 2025 (JP) 2025-006623

(51) Int. Cl. B60J 7/043; B60J 7/057

(52) U.S. Cl. CPC B60J 7/0435; B60J 7/0573

(57) ABSTRACT

A sunroof device includes a rear link that displaces a movable panel to a tilt-up position by being displaced to an upright position along with drive shoe movement. The rear link displaces the movable panel to a fully closed position by being displaced to a storage position along with movement of the drive shoe. The drive shoe includes a bottom wall, an inner wall extending upward from the bottom wall, and an outer wall extending upward from the bottom wall on an outer side of the inner wall in the width direction. The drive shoe transmits power for displacing the rear link. The rear link is disposed between the inner wall and the outer wall of the drive shoe, and a lip accommodation space that allows side lips of the movable panel to be accommodated is present between the rear link and the outer wall.

### CROSS REFERENCE TO RELATED APPLICATIONS

This application is based on and claims priority under 35 U.S.C. § 119 to Japanese Patent Application Nos. 2025-006623 and 2024-054691, respectively filed on Jan. 17, 2025, and Mar. 28, 2024, the entire contents of which are incorporated herein by reference.

### TECHNICAL FIELD

The present disclosure relates to a sunroof device.

### BACKGROUND DISCUSSION

International Publication No. 2015/114962 describes a vehicle including: a vehicle body having a roof opening; and a sunroof device installed in the roof opening. The sunroof device includes a movable panel that opens and closes the roof opening, and an opening and closing unit that drives the movable panel. The movable panel is driven by the opening and closing unit to perform an opening and closing operation between a fully closed position where the roof opening is fully closed and a tilt-up position where a rear end of the movable panel is lifted from the fully closed position.

When the vehicle travels in a state where the movable panel is arranged in the tilt-up position, wind noise may be generated due to traveling wind flowing near both ends in a width direction of the movable panel. Such wind noise tends to increase as a traveling speed of the vehicle increases. In this regard, the movable panel described in International Publication No. 2015/114962 suppresses the above-described wind noise by providing side lips at both end portions in the width direction.

When the vehicle travels, an upward load acts on the movable panel due to traveling wind flowing along an upper surface of the movable panel. Such an upward load tends to increase as the traveling speed of the vehicle increases. A need thus exists for a sunroof device which is not susceptible to the drawback mentioned above.

### SUMMARY

A sunroof device includes: a movable panel that operates between a fully closed position in which a roof opening of a vehicle is fully closed and a tilt-up position in which a rear end portion is lifted from the fully closed position; a guide rail having a longitudinal direction in a front-rear direction; a support bracket that supports the movable panel and has a longitudinal direction in the front-rear direction; a rear link that is displaced between a storage position and an upright position in a state of supporting a portion of the support bracket closer to a rear end than a front end of the support bracket; and a drive shoe that moves in the front-rear direction along the guide rail to drive the rear link. The movable panel includes a panel body that covers the roof opening, and side lips extending downward from both ends in a width direction of the panel body. The rear link displaces the movable panel to the tilt-up position by being displaced to the upright position along with movement of the drive shoe to one of forward or rearward, and the rear link displaces the movable panel to the fully closed position by being displaced to the storage position along with movement of the drive shoe to another one of forward or rearward. The drive shoe includes a bottom wall, an inner wall extending upward from the bottom wall, and an outer wall extending upward from the bottom wall on an outer side of the inner wall in the width direction, and the drive shoe transmits power for displacing the rear link to the rear link via both the inner wall and the outer wall. In the width direction, the rear link is disposed between the inner wall and the outer wall of the drive shoe, and a lip accommodation space that allows the side lips of the movable panel to be accommodated is present between the rear link and the outer wall.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle including a sunroof device;

FIG. 2 is a plan view illustrating a schematic configuration of the sunroof device of FIG. 1;

FIG. 3 is an exploded perspective view of a right half of a movable panel of the sunroof device of FIG. 1;

FIG. 4 is a side view of the movable panel of the sunroof device of FIG. 1;

FIG. 5 is a partially exploded perspective view of the sunroof device of FIG. 1;

FIG. 6 is a cross-sectional view of a guide rail of the sunroof device of FIG. 1;

FIG. 7 is an exploded perspective view of a rear portion of a drive mechanism of the sunroof device of FIG. 1;

FIG. 8 is an exploded perspective view of a rear portion of the drive mechanism of the sunroof device of FIG. 1;

FIG. 9 is a plan view of a rear portion of the drive mechanism of the sunroof device of FIG. 1;

FIG. 10 is a side view illustrating a schematic configuration of the sunroof device in FIG. 1;

FIG. 11 is a side view illustrating a schematic configuration of the sunroof device in FIG. 1;

FIG. 12 is a side view illustrating a schematic configuration of the sunroof device in FIG. 1;

FIG. 13 is a side view for explaining action of the sunroof device of FIG. 1;

FIG. 14 is a side view for explaining action of the sunroof device of FIG. 1;

FIG. 15 is a side view for explaining action of the sunroof device of FIG. 1;

FIG. 16 is a side view for explaining action of the sunroof device of FIG. 1;

FIG. 17 is a side view for explaining action of the sunroof device of FIG. 1;

FIG. 18 is a side view for explaining action of the sunroof device of FIG. 1;

FIG. 19 is a cross-sectional view taken along line XIX-XIX of the sunroof device of FIG. 13; and

FIG. 20 is a cross-sectional view taken along line XX-XX of the sunroof device of FIG. 17.

### DETAILED DESCRIPTION

Hereinafter, an embodiment of a sunroof device will be described with reference to the drawings. For hatching indicating a cross section of a member in the figures, the same type of hatching is used regardless of a material of the member.

### Configuration of Present Embodiment

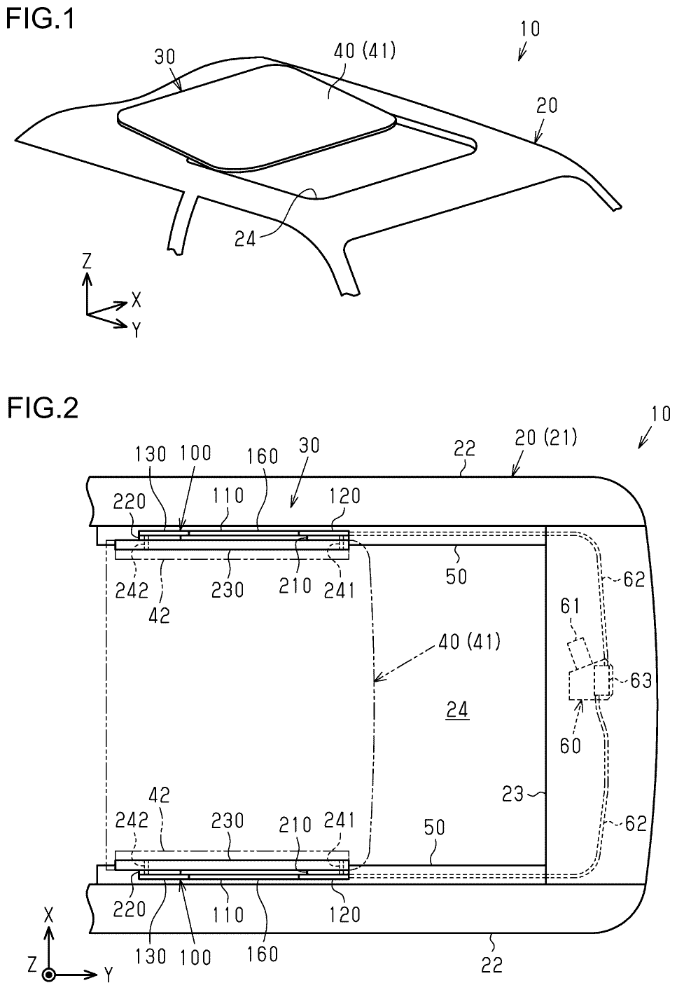

As illustrated in FIG. 1, a vehicle 10 includes a vehicle body 20 and a sunroof device 30. In the figure, an extending direction of an X axis indicates a width direction of the vehicle 10, an extending direction of a Y axis indicates a front-rear direction of the vehicle 10, and an extending direction of a Z axis indicates an up-down direction of the vehicle 10. In the following description, the width direction of the vehicle 10, the front-rear direction of the vehicle 10, and the up-down direction of the vehicle 10 are also referred to as a width direction, a front-rear direction, and an up- down direction, respectively. Further, in the width direction, a direction away from a center of the vehicle 10 is also referred to as an outer side, and a direction approaching the center of the vehicle 10 is also referred to as an inner side.

### Vehicle Body 20

As illustrated in FIG. 2, the vehicle body 20 includes a roof structure 21 constituting a framework of a roof. The roof structure 21 includes two side panels 22 and a front panel 23.

The two side panels 22 have an elongated plate shape. A longitudinal direction of the side panel 22 is the front-rear direction, and a plate thickness direction of the side panel 22 is the up-down direction. The two side panels 22 are located with an interval in the width direction. The front panel 23 has an elongated plate shape. A longitudinal direction of the front panel 23 is the width direction, and a plate thickness direction of the front panel 23 is the up-down direction. The front panel 23 connects front ends of the two side panels 22, in the width direction. Further, the roof structure 21 has a roof opening 24 defined by the two side panels 22 and the front panel 23. The roof opening 24 has a rectangular shape. The roof opening 24 can take various shapes according to a vehicle type.

### Sunroof Device 30

As illustrated in FIG. 2, the sunroof device 30 includes a movable panel 40, two guide rails 50, a driving unit 60, and two drive mechanisms 100. A width direction, a front-rear direction, and an up-down direction of the sunroof device 30 coincide with the width direction, the front-rear direction, and the up-down direction of the vehicle 10, respectively.

### Movable Panel 40

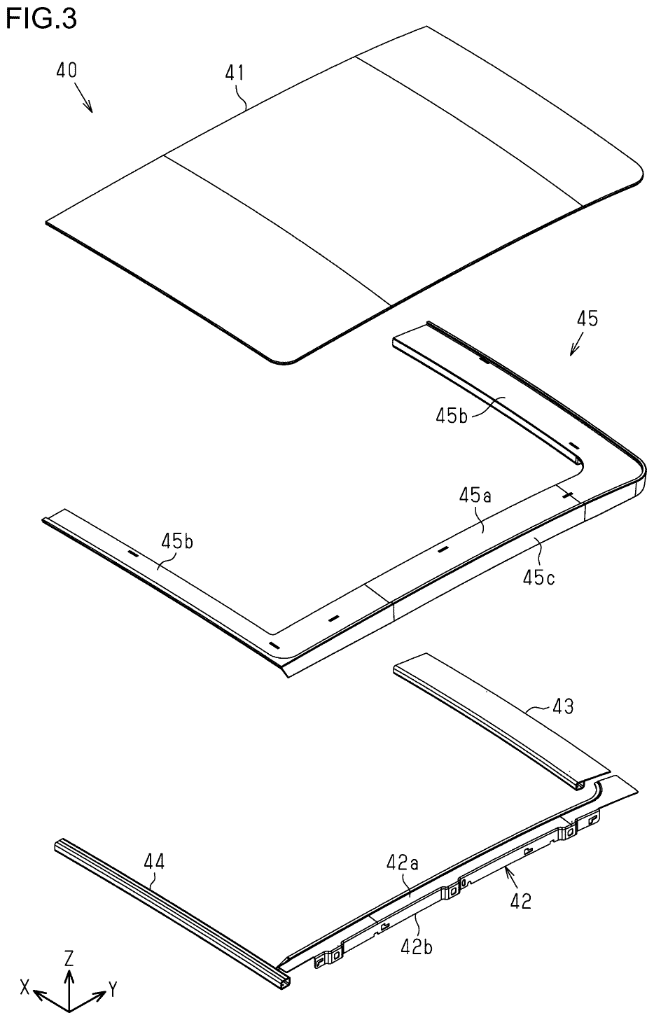

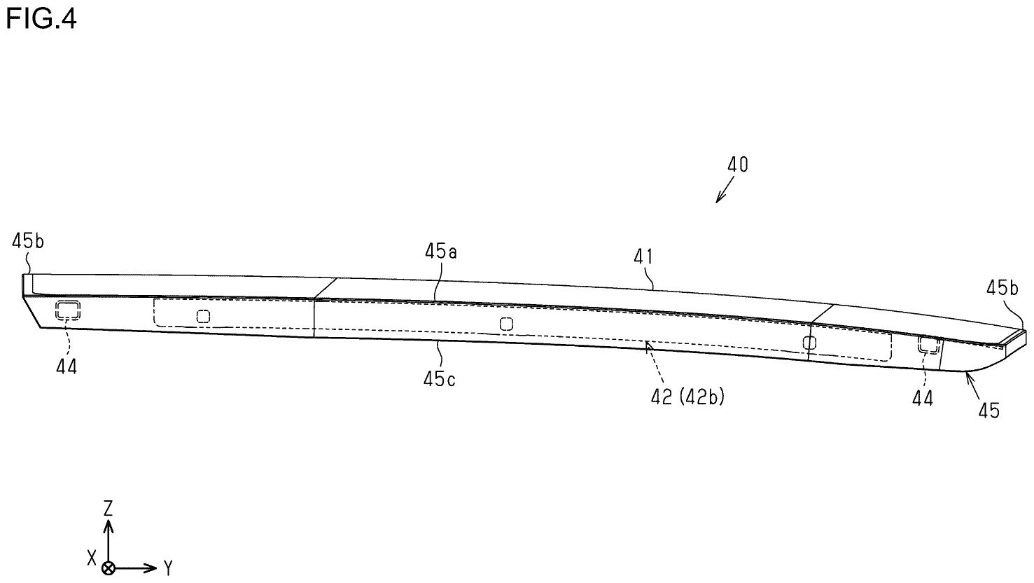

As illustrated in FIGS. 3 and 4, the movable panel 40 includes a panel body 41, two panel brackets 42, two reinforcing members 43 and 44, and a joining frame 45. Note that FIG. 3 is a perspective view illustrating a right half of the movable panel 40, and thus illustration of some components of the movable panel 40 is omitted.

The panel body 41 is made of a material such as glass or resin through which light can pass. The panel body 41 has a size corresponding to the roof opening 24. The panel body 41 may be curved with respect to at least one of the width direction or the front-rear direction.

The panel bracket 42 is made of a material having high rigidity, such as metal. The panel bracket 42 is an elongated member. A longitudinal direction of the panel bracket 42 is the front-rear direction. The panel bracket 42 includes a joining plate 42a having a flat plate shape and a fixing plate 42b having a flat plate shape. A plate thickness direction of the joining plate 42a is the up-down direction. A plate thickness direction of the fixing plate 42b is the width direction. The fixing plate 42b extends downward from an end portion on the outer side in the width direction of the joining plate 42a. In this regard, a cross-sectional shape orthogonal to the longitudinal direction of the panel bracket 42 is an L shape. The two panel brackets 42 are located with an interval in the width direction. That is, the two panel brackets 42 are located on both sides in the width direction of the panel body 41.

The reinforcing members 43 and 44 are made of a material having high rigidity, such as metal. The reinforcing member 43 includes an elongated tubular portion and an elongated flat plate-shaped portion. Whereas, the reinforcing member 44 includes an elongated tubular portion. A longitudinal direction of the reinforcing members 43 and 44 is the width direction. The two reinforcing members 43 and 44 are located with an interval from each other in the front-rear direction. Specifically, the reinforcing member 43 is disposed along a front end of the panel body 41, and the reinforcing member 44 is disposed along a rear end of the panel body 41.

The joining frame 45 is made of a resin material. The joining frame 45 has a rectangular frame shape when viewed from above. The joining frame 45 includes two first joint portions 45a, two second joint portions 45b, and two side lips 45c. The joining frame 45 is molded by, for example, RIM molding or injection molding.

The first joint portion 45a has an elongated plate shape. A longitudinal direction of the first joint portion 45a is the front-rear direction. The two first joint portions 45a are located with an interval in the width direction. The two first joint portions 45a join the two joining plates 42a of the panel bracket 42 to the panel body 41. Further, the two first joint portions 45a individually cover a right end and a left end of the panel body 41. The second joint portion 45b has an elongated plate shape. A longitudinal direction of the second joint portion 45b is the width direction. The two second joint portions 45b are located with an interval in the front-rear direction. The two second joint portions 45b individually cover the reinforcing members 43 and 44, and individually join the reinforcing members 43 and 44 to the panel body 41. Further, the two second joint portions 45b individually cover the front end and the rear end of the panel body 41.

The two side lips 45c extend downward from the two first joint portions 45a. That is, the two side lips 45c extend downward from both end portions in the width direction of the panel body 41. A length of the two side lips 45c in the front-rear direction is equal to a length of the panel body 41 in the front-rear direction. In this regard, it can be said that the two side lips 45c are provided over the front-rear direction of the panel body 41. As illustrated in FIG. 4, when the movable panel 40 is viewed from the width direction, the panel bracket 42 is hidden by the side lip 45c. In the present embodiment, the side lip 45c extends downward from an end portion on the outer side in the width direction of the first joint portion 45a. However, in another embodiment, the side lip 45c may extend downward from any position of the first joint portion 45a.

The movable panel 40 is driven by the driving unit 60 and the two drive mechanisms 100 to be described later. Specifically, the movable panel 40 is displaced between a fully closed position, a tilt-up position, a lift-up position, and a fully open position. The fully closed position is a position of the movable panel 40 when the roof opening 24 is fully closed. The tilt-up position is a position of the movable panel 40 when a rear end portion of the movable panel 40 is lifted from the fully closed position. The lift-up position is a position of the movable panel 40 when a front end portion of the movable panel 40 is lifted from the tilt-up position. The fully opened position is a position of the movable panel 40 when the roof opening 24 is fully opened.

### Guide Rail 50

As illustrated in FIG. 2, the guide rail 50 is an elongated member. The two guide rails 50 are disposed on both sides in the width direction of the roof opening 24. The two guide rails 50 are individually fixed to the two side panels 22 via fastening members such as bolts, for example. The two guide rails 50 have a symmetrical shape with respect to the width direction. In the following description, the guide rail 50 on one side in the width direction will be described.

A longitudinal direction of the guide rail 50 is the front-rear direction. The guide rail 50 is curved with respect to the front-rear direction when viewed from the width direction. In the present embodiment, the guide rail 50 extending in the front-rear direction includes both a guide rail 50 extending straight in the front-rear direction and a guide rail 50 extending in the front-rear direction while being curved. Further, in order to simplify the following description, the longitudinal direction of the guide rail 50 is regarded as the front-rear direction, and a direction orthogonal to both the longitudinal direction and the width direction of the guide rail 50 is regarded as the up-down direction.

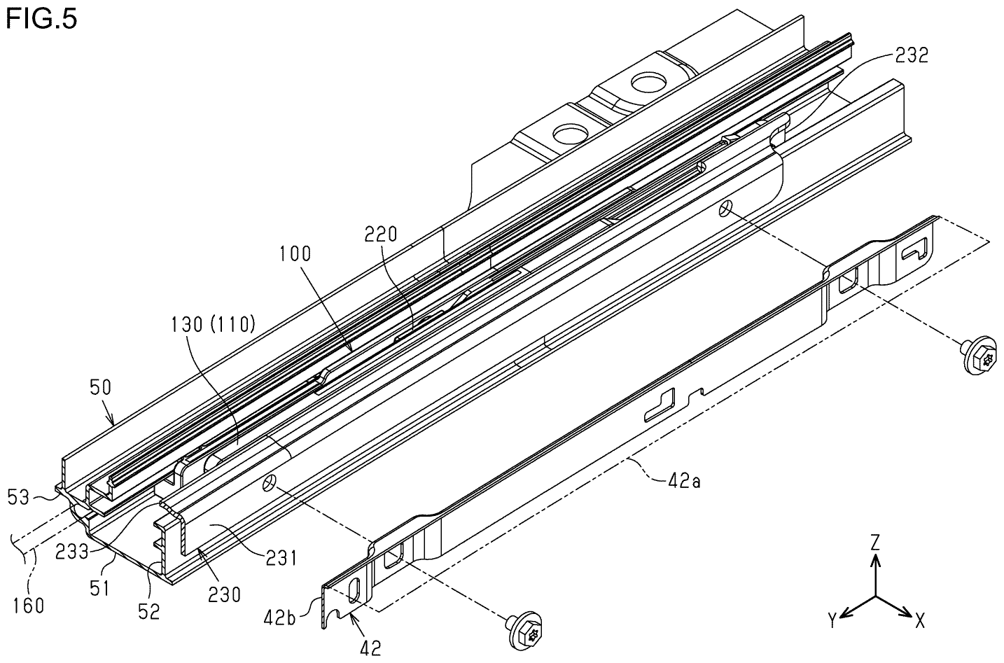

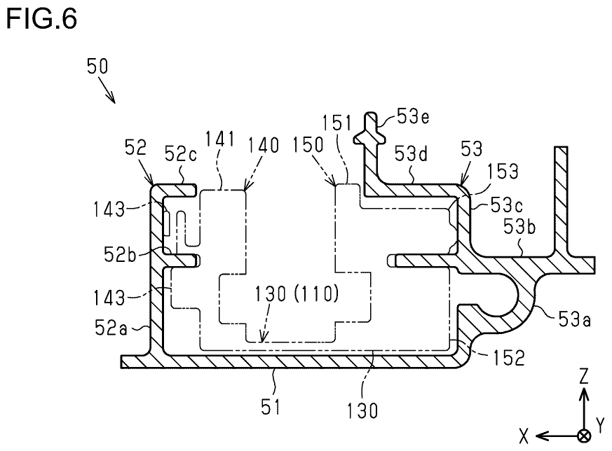

As illustrated in FIGS. 5 and 6, the guide rail 50 includes a lower guide wall 51, an inner guide wall 52, and an outer guide wall 53. The guide rail 50 is formed by performing, for example, extruding processing or press processing on a metal material. A cross-sectional shape orthogonal to the longitudinal direction of the guide rail 50 is substantially uniform with respect to the longitudinal direction.

As illustrated in FIG. 6, the lower guide wall 51 has a plate shape. A plate thickness direction of the lower guide wall 51 is the up-down direction. In the following description, an end portion on the inner side in the width direction of the lower guide wall 51 is referred to as an inner end, and an end portion on the outer side in the width direction of the lower guide wall 51 is referred to as an outer end.

The inner guide wall 52 extends upward from a position closer to the inner end than the outer end of the lower guide wall 51. The inner guide wall 52 includes a first inner guide wall 52a, a second inner guide wall 52b, and a third inner guide wall 52c. The first inner guide wall 52a extends upward from the lower guide wall 51. The second inner guide wall 52b extends outward in the width direction from the first inner guide wall 52a. The third inner guide wall 52c extends outward in the width direction from the first inner guide wall 52a, above the second inner guide wall 52b. In other words, the third inner guide wall 52c extends outward in the width direction from a distal end of the first inner guide wall 52a. There is a gap between the second inner guide wall 52b and the lower guide wall 51, and there is a gap between the second inner guide wall 52b and the third inner guide wall 52c.

The outer guide wall 53 extends upward from a position closer to the outer end than the inner end of the lower guide wall 51. That is, the outer guide wall 53 is located outward of the inner guide wall 52 in the width direction. The outer guide wall 53 includes a first outer guide wall 53a, a second outer guide wall 53b, a third outer guide wall 53c, a fourth outer guide wall 53d, and a fifth outer guide wall 53e.

The first outer guide wall 53a extends outward in the width direction as proceeding upward from the lower guide wall 51. In a cross-sectional shape orthogonal to the longitudinal direction of the guide rail 50, the first outer guide wall 53a is curved in an arc shape. The second outer guide wall 53b extends inward and outward in the width direction from an upper end of the first outer guide wall 53a. The third outer guide wall 53c extends upward from a portion, in the second outer guide wall 53b, extending inward in the width direction from the first outer guide wall 53a. The fourth outer guide wall 53d extends inward in the width direction from an upper end of the third outer guide wall 53c. The fifth outer guide wall 53e extends upward from an inner end of the fourth outer guide wall 53d. There is a gap between the second inner guide wall 52b and the lower guide wall 51, and there is a gap between the second outer guide wall 53b and the fourth outer guide wall 53d.

### Driving Unit 60

As illustrated in FIG. 2, the driving unit 60 includes an electric motor 61, two cables 62 driven by the electric motor 61, and a conversion mechanism 63 that converts rotational motion of an output shaft of the electric motor 61 into linear motion of the cable 62. The electric motor 61 and the conversion mechanism 63 are fixed to a central portion of the front panel 23 in the width direction. The cable 62 is, for example, a push-pull cable. The cable 62 is routed along the front panel 23 and the guide rail 50. Specifically, the cable 62 is accommodated between the first outer guide wall 53a and the second outer guide wall 53b in the guide rail 50.

### Drive Mechanism 100

As illustrated in FIG. 2, the two drive mechanisms 100 individually correspond to the two guide rails 50. The two drive mechanisms 100 have symmetrical shapes with respect to the width direction. In the following description, the drive mechanism 100 on one side in the width direction will be described.

As illustrated in FIGS. 2, 7, and 8, the drive mechanism 100 includes a drive shoe 110, a front link 210, a rear link 220, a support bracket 230, a front connecting shaft 241, and a rear connecting shaft 242. Components of the drive mechanism 100 are preferably made of at least one of a metal material or a resin material.

### Drive Shoe 110

As illustrated in FIG. 2, the drive shoe 110 includes a front shoe 120, a rear shoe 130, and a power transmission member 160.

### Front Shoe 120

The front shoe 120 is accommodated in the guide rail 50. The front shoe 120 is movable with respect to the guide rail 50 in the longitudinal direction of the guide rail 50, but is not movable in a direction orthogonal to the longitudinal direction of the guide rail 50. To the front shoe 120, an end portion of the cable 62 of the driving unit 60 is connected. Therefore, when the driving unit 60 feeds the cable 62, the front shoe 120 moves rearward while sliding on the guide rail 50. Whereas, when the driving unit 60 returns the cable 62, the front shoe 120 moves forward while sliding on the guide rail 50.

### Rear Shoe 130

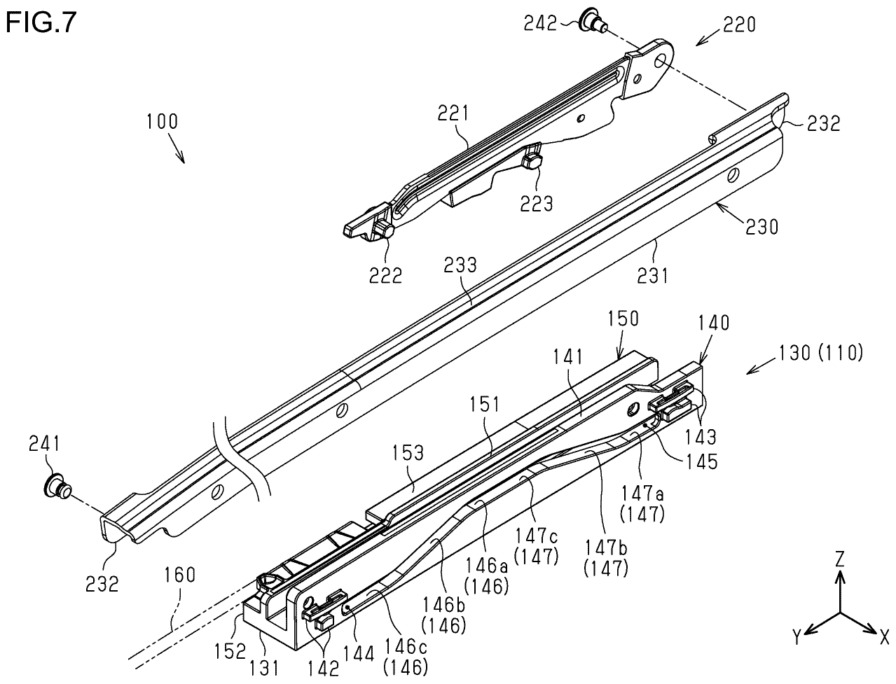

As illustrated in FIGS. 7, 8, and 9, the rear shoe 130 includes a bottom wall 131, an inner wall 140, and an outer wall 150.

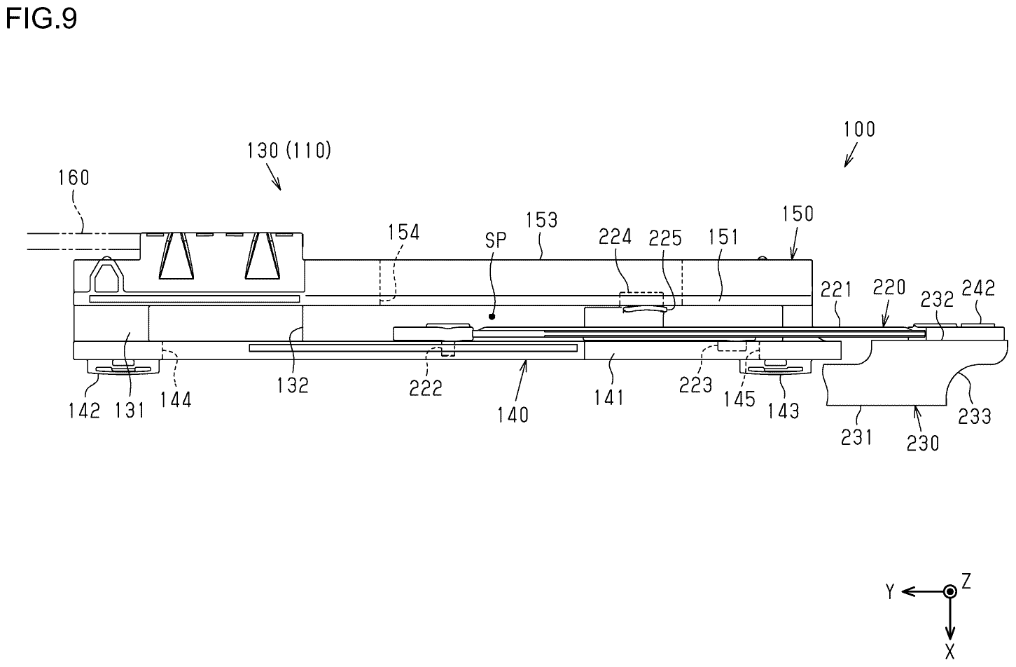

The bottom wall 131 has a rectangular plate shape. A longitudinal direction of the bottom wall 131 is the front-rear direction, a lateral direction of the bottom wall 131 is the width direction, and a plate thickness direction of the bottom wall 131 is the up-down direction. As illustrated in FIG. 9, the bottom wall 131 has a retraction hole 132 penetrating the bottom wall 131 in the plate thickness direction. When the bottom wall 131 is viewed from the up-down direction, the retraction hole 132 has a rectangular shape. The retraction hole 132 is located closer to a distal end of the bottom wall 131 than a rear end of the bottom wall 131.

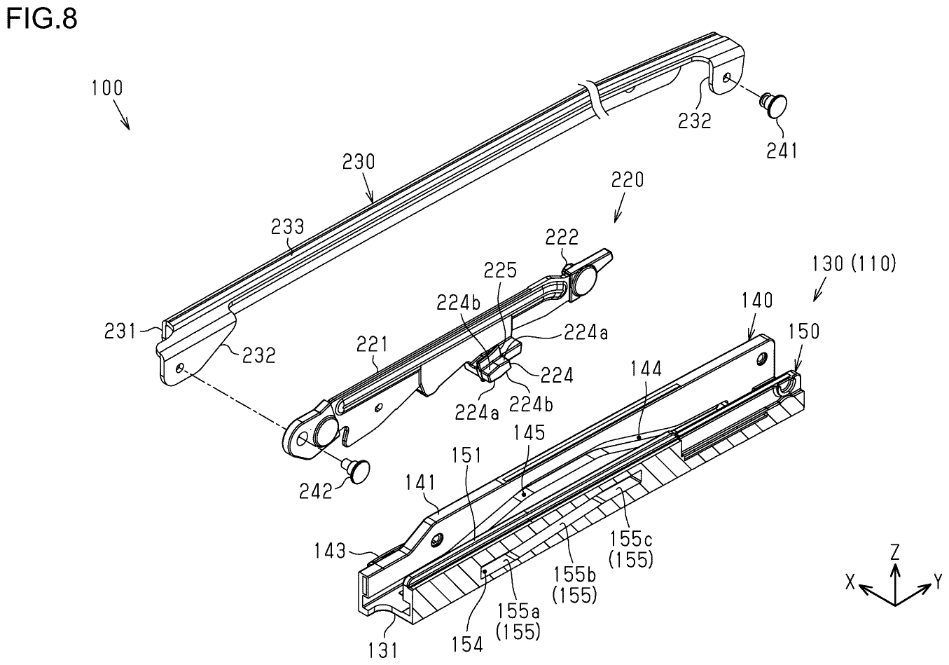

As illustrated in FIGS. 7 and 8, the inner wall 140 extends upward from an inner end in the width direction of the bottom wall 131. The inner wall 140 includes an inner wall body 141 and two inner holding portions 142 and 143.

The inner wall body 141 has a rectangular plate shape. A longitudinal direction of the inner wall body 141 is the front-rear direction, a lateral direction of the inner wall body 141 is the up-down direction, and a plate thickness method of the inner wall body 141 is the width direction. The inner wall body 141 includes a first inner sliding groove 144 and a second inner sliding groove 145 that penetrate the inner wall body 141 in the plate thickness direction. An inner surface of the first inner sliding groove 144 is a first inner sliding surface 146 intersecting the width direction. The first inner sliding surface 146 includes a first portion 146a extending forward, a second portion 146b extending downward as proceeding forward from a front end of the first portion 146a, and a third portion 146c extending forward from a front end of the second portion 146b. An inner surface of the second inner sliding groove 145 is a second inner sliding surface 147 intersecting the width direction. The second inner sliding surface 147 includes a first portion 147a extending forward, a second portion 147b extending upward as proceeding forward from a front end of the first portion 147a, and a third portion 147c extending forward from a front end of the second portion 147b.

In the present embodiment, the first inner sliding groove 144 is connected to the second inner sliding groove 145 in the front-rear direction. Therefore, a rear end of the first portion 146a of the first inner sliding surface 146 is connected to a front end of the third portion 147c of the second inner sliding surface 147 in the front-rear direction. In another embodiment, the first inner sliding groove 144 may be separated from the second inner sliding groove 145.

Further, the first inner sliding surface 146 is a pair of upper and lower surfaces, and the second inner sliding surface 147 is a pair of upper and lower surfaces. In FIG. 7 and the like, for convenience of illustration, one of the pair of upper and lower first inner sliding surfaces 146 is denoted by a reference sign, and one of the pair of upper and lower second inner sliding surfaces 147 is denoted by a reference sign. Further, the first portion 146a, the second portion 146b, and the third portion 146c of the first inner sliding surface 146 and the first portion 147a, the second portion 147b, and the third portion 147c of the second inner sliding surface 147 are also similarly denoted by reference numerals.

The two inner holding portions 142 and 143 are provided with an interval in the front-rear direction, on a surface facing inward in the width direction of the inner wall body 141. The inner holding portion 142 on a front side is provided forward of the first inner sliding groove 144, and the inner holding portion 143 on a rear side is provided rearward of the second inner sliding groove 145. The inner holding portions 142 and 143 each are two protrusions provided with an interval in the up-down direction.

The outer wall 150 extends upward from an outer end in the width direction of the bottom wall 131. The outer wall 150 has an outer wall body 151, a lower sliding wall 152, and an upper sliding wall 153.

The outer wall body 151 has a rectangular plate shape. A longitudinal direction of the outer wall body 151 is the front-rear direction, a lateral direction of the outer wall body 151 is the up-down direction, and a plate thickness method of the outer wall body 151 is the width direction. The outer wall body 151 faces the inner wall body 141 in the width direction. An upper end of the outer wall body 151 is located downward of an upper end of the inner wall body 141. In this regard, a height of the outer wall 150 is lower than a height of the inner wall 140.

The outer wall body 151 has an outer sliding groove 154 penetrating the outer wall body 151 in the plate thickness direction. An inner surface of the outer sliding groove 154 is an outer sliding surface 155 intersecting the width direction. The outer sliding surface 155 includes a first portion 155a extending forward, a second portion 155b extending upward as proceeding forward from a front end of the first portion 155a, and a third portion 155c extending forward from a front end of the second portion 155b. When the rear shoe 130 is viewed from the width direction, the second portion 155b of the outer sliding surface 155 is inclined in the same direction as the second portion 147b of the second inner sliding surface 147. However, the inclination of the second portion 155b of the outer sliding surface 155 with respect to the front-rear direction is smaller than the inclination of the second portion 147b of the second inner sliding surface 147 with respect to the front-rear direction. The lower sliding wall 152 and the upper sliding wall 153 extend outward from an outer surface of the outer wall body 151 in the width direction. The lower sliding wall 152 is located below the upper sliding wall 153. There is a gap between the lower sliding wall 152 and the upper sliding wall 153.

In the present embodiment, the outer sliding surface 155 is a pair of upper and lower surfaces. In FIG. 8 and the like, one of the pair of upper and lower outer sliding surfaces 155 is denoted by a reference sign for convenience of illustration. Further, the first portion 155a, the second portion 155b, and the third portion 155c of the outer sliding surface 155 are also similarly denoted by the reference numerals.

As illustrated in FIG. 2, the rear shoe 130 is accommodated in the guide rail 50 similarly to the front shoe 120. As illustrated in FIG. 6, the bottom wall 131 of the rear shoe 130 faces the lower guide wall 51 of the guide rail 50. The inner holding portions 142 and 143 of the rear shoe 130 hold the second inner guide wall 52b of the guide rail 50 in the up-down direction. Whereas, the lower sliding wall 152 and the upper sliding wall 153 of the rear shoe 130 sandwich the second outer guide wall 53b of the guide rail 50 in the up-down direction. Further, the rear shoe 130 is sandwiched between the inner guide wall 52 and the outer guide wall 53 of the guide rail 50 in the width direction. As a result, the rear shoe 130 is movable in the longitudinal direction of the guide rail 50, but is not movable in the direction orthogonal to the longitudinal direction of the guide rail 50.

### Power Transmission Member 160

As illustrated in FIGS. 2, 7, and 8, the power transmission member 160 connects the front shoe 120 and the rear shoe 130 so as to be able to transmit power. It suffices that the power transmission member 160 is, for example, a push-pull cable. The power transmission member 160 is accommodated between the first outer guide wall 53a and the second outer guide wall 53b of the guide rail 50. When the front shoe 120 moves forward, the rear shoe 130 moves forward similarly to the front shoe 120. Whereas, when the front shoe 120 moves rearward, the rear shoe 130 moves rearward similarly to the front shoe 120. That is, an amount of movement of the front shoe 120 in the front-rear direction coincides with an amount of movement of the rear shoe 130 in the front-rear direction, ignoring slight elastic deformation of the power transmission member 160.

### Front Link 210

As illustrated in FIG. 2, the front link 210 is accommodated in the guide rail 50 in a state of being engaged with the front shoe 120. The front link 210 moves along the guide rail 50 on the basis of power transmitted from the front shoe 120. Further, the front link 210 rises or falls with respect to the guide rail 50 on the basis of the power transmitted from the front shoe 120. In other words, a distal end portion of the front link 210 is lifted with respect to a proximal end portion of the front link 210, or the distal end portion of the front link 210 is lowered with respect to the proximal end portion of the front link 210.

### Rear Link 220

As illustrated in FIGS. 7 to 9, the rear link 220 includes a link body 221, a first inner sliding shaft 222, a second inner sliding shaft 223, an outer sliding shaft 224, and an outer regulating wall 225. The link body 221 has an elongated flat plate shape. A plate thickness direction of the link body 221 is the width direction.

The first inner sliding shaft 222 and the second inner sliding shaft 223 protrude inward in the width direction from the link body 221. The first inner sliding shaft 222 protrudes from a front end portion of the link body 221. The second inner sliding shaft 223 protrudes from a portion on a rear side of the front end portion of the link body 221. A cross-sectional shape orthogonal to a protruding direction of the first inner sliding shaft 222 and the second inner sliding shaft 223 is non- circular. Specifically, side surfaces of the first inner sliding shaft 222 and the second inner sliding shaft 223 include two peripheral surfaces and two flat surfaces.

The outer sliding shaft 224 protrudes outward in the width direction from the link body 221. When the rear link 220 is viewed from the width direction, the outer sliding groove 154 is located between the first inner sliding shaft 222 and the second inner sliding shaft 223 in a longitudinal direction of the link body 221. A cross-sectional shape orthogonal to a protruding direction of the outer sliding shaft 224 is a hexagonal shape. That is, side surfaces of the outer sliding shaft 224 include six planar surfaces. In the following description, two flat surfaces extending in parallel among the six flat surfaces of the outer sliding shaft 224 are referred to as first flat surfaces 224a. Two flat surfaces extending in parallel among the four flat surfaces of the outer sliding shaft 224 excluding the first flat surface 224a from among the six flat surfaces are referred to as second flat surfaces 224b. The outer regulating wall 225 extends from the outer sliding shaft 224 in a direction orthogonal to the protruding direction of the outer sliding shaft 224. The outer regulating wall 225 has a plate shape. A cross-sectional shape orthogonal to a protruding direction of the outer regulating wall 225 is an arc shape.

The rear link 220 is engaged with the rear shoe 130. Specifically, the rear link 220 is sandwiched between the inner wall 140 and the outer wall 150 of the rear shoe 130. At this time, the first inner sliding shaft 222 of the rear link 220 is disposed inside the first inner sliding groove 144 of the rear link 220, and the second inner sliding shaft 223 of the rear link 220 is disposed inside the second inner sliding groove 145 of the rear link 220. Whereas, the outer sliding shaft 224 of the rear link 220 is disposed inside the outer sliding groove 154 of the rear link 220. At this time, an axial direction of the first inner sliding shaft 222, the second inner sliding shaft 223, and the outer sliding shaft 224 is the width direction.

As illustrated in FIG. 9, the outer regulating wall 225 of the rear link 220 is in contact with the outer wall 150 of the rear shoe 130. In this way, the rear link 220 is not movable in the width direction with respect to the rear shoe 130, but is movable in a direction orthogonal to the width direction with respect to the rear shoe 130. Further, a gap between the rear link 220 and the inner wall 140 of the rear shoe 130 is small, and a gap between the rear link 220 and the outer wall 150 of the rear shoe 130 is large. A space between the rear link 220 and the outer wall 150 of the rear shoe 130 is a lip accommodation space SP capable of accommodating the side lip 45c of the movable panel 40.

### Support Bracket 230

As illustrated in FIGS. 7 to 9, the support bracket 230 includes a panel connecting portion 231, two link connecting portions 232, and an intermediate portion 233. The link connecting portion 232, the panel connecting portion 231, and the intermediate portion 233 have a plate shape. A plate thickness direction of the panel connecting portion 231 and a plate thickness direction of the link connecting portion 232 are the width direction. The panel connecting portion 231 extends in the front-rear direction. The two link connecting portions 232 are located with an interval in the front-rear direction. The intermediate portion 233 connects an upper end of the panel connecting portion 231 and upper ends of the two link connecting portions 232.

As illustrated in FIG. 5, the panel connecting portion 231 of the support bracket 230 is connected to the fixing plate 42b of the panel bracket 42, by a fastening member such as a bolt. That is, the support bracket 230 is integrated with the panel bracket 42. Whereas, as illustrated in FIGS. 2, 7, and 8, the link connecting portion 232 on a front side of the support bracket 230 is connected to the front end portion of the front link 210 via the front connecting shaft 241. In this way, the support bracket 230 and the front link 210 are relatively rotatable about an axis of the front connecting shaft 241. In addition, it can be said that the front link 210 supports a portion closer to a front end than a rear end of the support bracket 230. Similarly, the link connecting portion 232 on a rear side of the support bracket 230 is connected to a rear end portion of the rear link 220 via the rear connecting shaft 242. In this way, the support bracket 230 and the rear link 220 are relatively rotatable about an axis of the rear connecting shaft 242. Further, it can be said that the rear link 220 supports a portion closer to the rear end than the front end of the support bracket 230. A direction in which the axes of the front connecting shaft 241 and the rear connecting shaft 242 extend is the width direction.

### Action of Present Embodiment

Action at the time of an opening operation of the movable panel 40 will be described. The action at the time of a closing operation of the movable panel 40 is substantially similar to action at the time of the opening operation of the movable panel 40, except that an operating direction of operating components of the sunroof device 30 is opposite. Therefore, the description of the action at the time of the closing operation of the movable panel 40 is omitted.

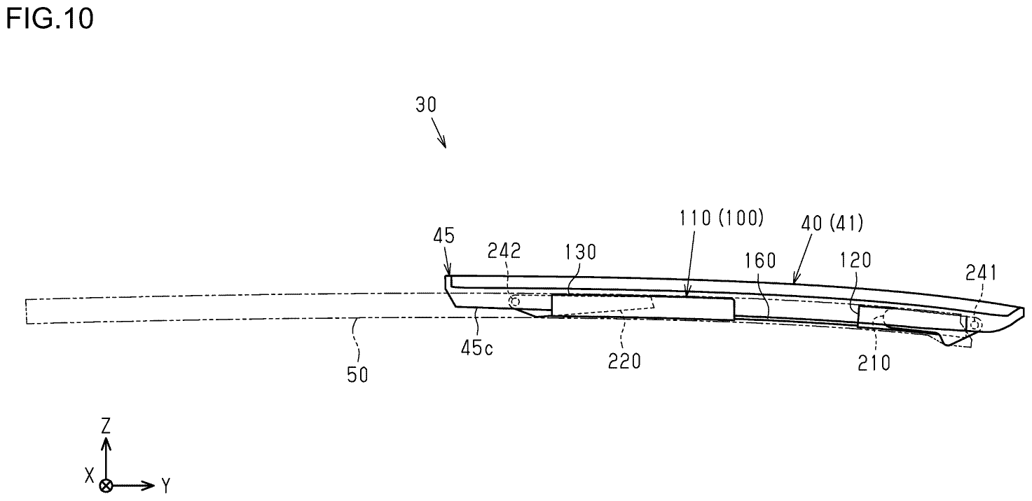

FIG. 10 illustrates the sunroof device 30 when the movable panel 40 is arranged in the fully closed position. The position of the drive shoe 110 illustrated in FIG. 10 is a full-close corresponding position for causing the movable panel 40 to be arranged in the fully closed position. The full-close corresponding position is the foremost position in a movement range of the drive shoe 110. When the movable panel 40 is caused to perform the opening operation from the fully closed position, the driving unit 60 moves the drive shoe 110 rearward.

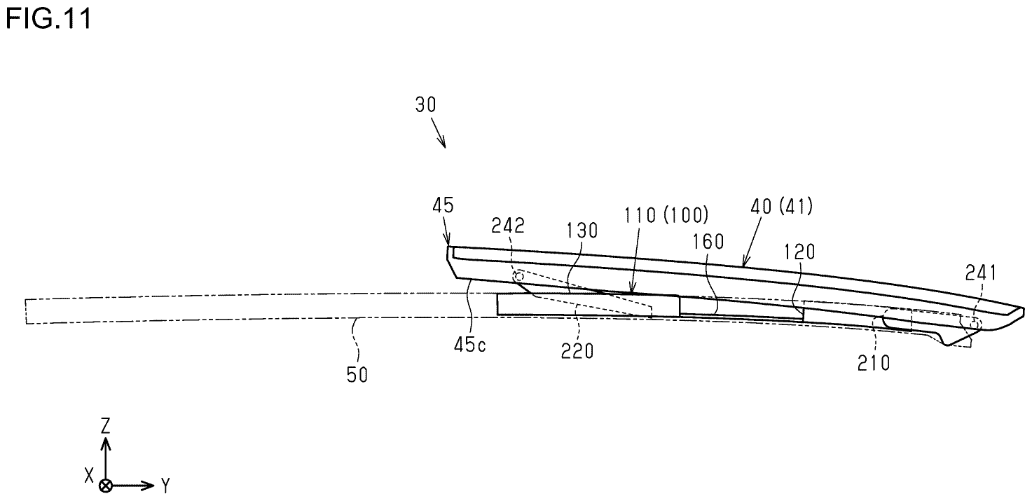

As illustrated in FIGS. 10 and 11, when the drive shoe 110 moves rearward from the full-close corresponding position, the rear link 220 rises with respect to the guide rail 50 so that the rear connecting shaft 242 is lifted. As illustrated in FIG. 11, when the drive shoe 110 reaches a tilt-up corresponding position, a rising amount of the rear link 220 with respect to the guide rail 50 becomes maximum. As a result, the movable panel 40 is arranged in the tilt-up position.

Although not illustrated, when the drive shoe 110 moves rearward from the tilt-up corresponding position, the front link 210 rises with respect to the guide rail 50 such that the front connecting shaft 241 is lifted. When the drive shoe 110 reaches a lift-up corresponding position, a rising amount of the front link 210 with respect to the guide rail 50 becomes maximum. As a result, the movable panel 40 is arranged in the lift-up position.

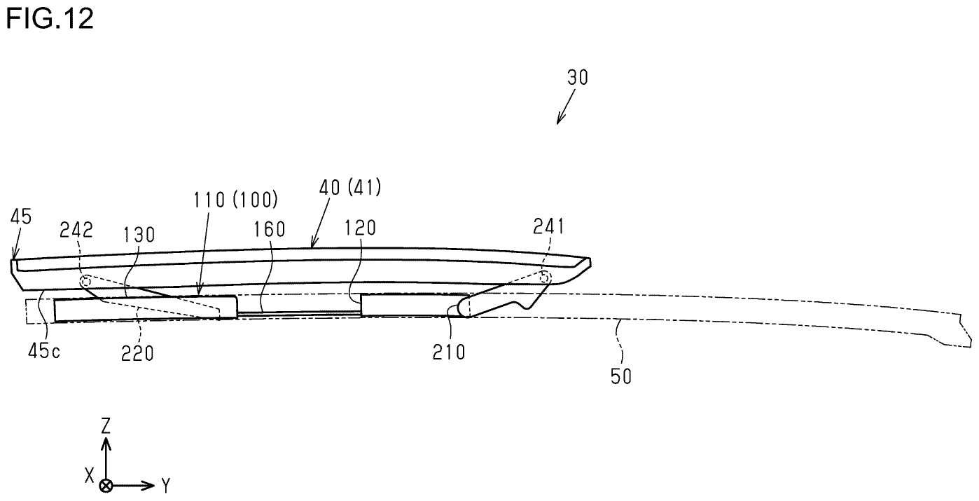

As illustrated in FIG. 12, when the drive shoe 110 moves rearward from the lift-up corresponding position, the front link 210 and the rear link 220 move rearward while maintaining a standing state. Then, the movable panel 40 moves rearward along the guide rail 50. When the drive shoe 110 reaches the full-close corresponding position, the movable panel 40 moves to the rearmost position in a movement range in the front-rear direction. As a result, the movable panel 40 is arranged in the fully open position.

Hereinafter, an engagement relationship between the rear shoe 130 and the rear link 220 when the drive shoe 110 moves from the full-close corresponding position to the tilt-up corresponding position will be described in detail.

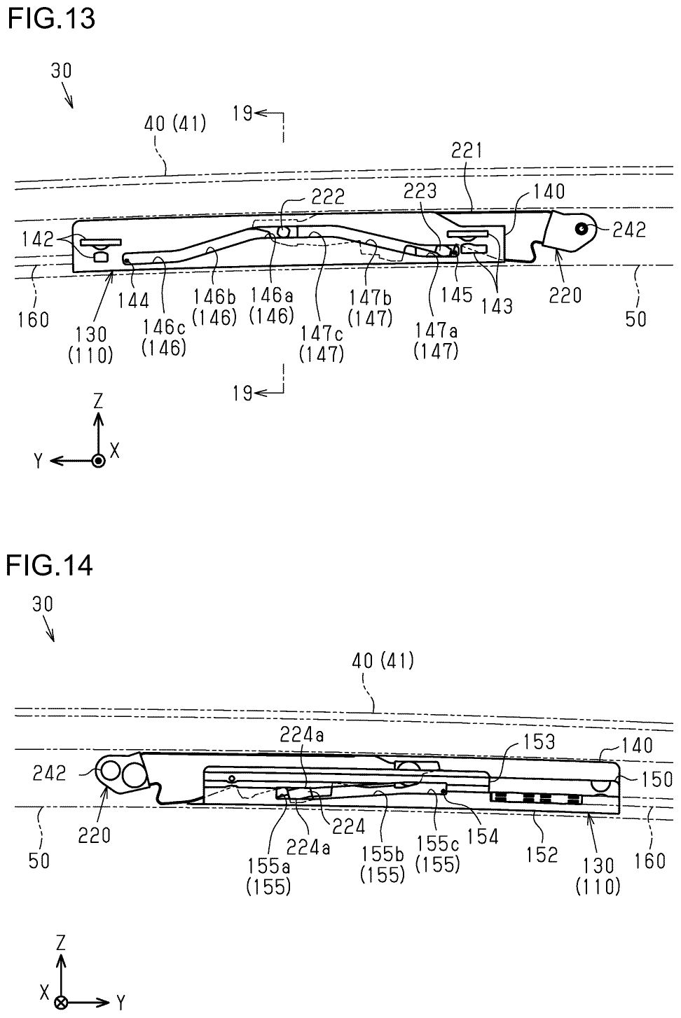

As illustrated in FIGS. 13 and 14, when the drive shoe 110 is located at the full-close corresponding position, the first inner sliding shaft 222 of the rear link 220 is located near a rear end of the first inner sliding groove 144 of the rear shoe 130. Specifically, the first inner sliding shaft 222 is in contact with the first portion 146a of the first inner sliding surface 146. Further, the second inner sliding shaft 223 of the rear link 220 is located near a rear end of the second inner sliding groove 145 of the rear shoe 130. Specifically, the second inner sliding shaft 223 is in contact with the first portion 147a of the second inner sliding surface 147. In this regard, the first inner sliding shaft 222 is located upward of the second inner sliding shaft 223. Whereas, the outer sliding shaft 224 of the rear link 220 is located near a rear end of the outer sliding groove 154 of the rear shoe 130. Specifically, the outer sliding shaft 224 is in contact with the first portion 155a of the outer sliding surface 155 via the two first flat surfaces 224a. In this way, the rear link 220 is arranged in a storage position of being tilted along the guide rail 50.

In the present embodiment, when the rear link 220 is located at the storage position, the entire rear link 220 is hidden by the guide rail 50. Whereas, in another embodiment, when the rear link 220 is located at the storage position, a part of the rear link 220 may be exposed from the guide rail 50.

When the drive shoe 110 starts to move rearward from the full-close corresponding position, the rear shoe 130 slides on the rear link 220. Specifically, the first inner sliding shaft 222 of the rear link 220 slides on the first portion 146a, the second portion 146b, and the third portion 146c of the first inner sliding surface 146 of the rear shoe 130 in this order. Further, the second inner sliding shaft 223 of the rear link 220 slides on the first portion 147a, the second portion 147b, and the third portion 147c of the second inner sliding surface 147 of the rear shoe 130 in this order. Whereas, the outer sliding shaft 224 of the rear link 220 slides on the first portion 155a, the second portion 155b, and the third portion 155c of the outer sliding surface 155 of the rear shoe 130 in this order.

As illustrated in FIGS. 13 and 14, the first portion 146a of the first inner sliding surface 146, the first portion 147a of the second inner sliding surface 147, and the first portion 155a of the outer sliding surface 155 extend in the longitudinal direction of the guide rail 50. Therefore, when the first inner sliding shaft 222, the second inner sliding shaft 223, and the outer sliding shaft 224 slide on the first portion 146a of the first inner sliding surface 146, the first portion 147a of the second inner sliding surface 147, and the first portion 155a of the outer sliding surface 155, respectively, a posture of the rear link 220 does not change much. Further, when the outer sliding shaft 224 slides on the first portion 155a of the outer sliding surface 155, the first flat surface 224a slides on the first portion 155a.

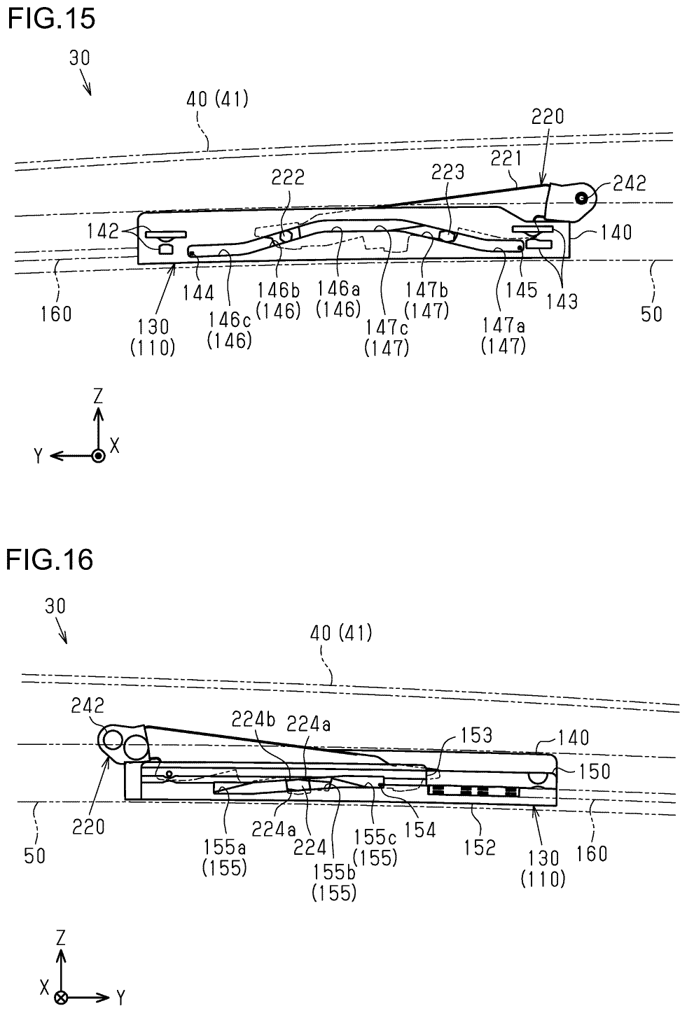

As illustrated in FIGS. 15 and 16, the second portion 146b of the first inner sliding surface 146, the second portion 147b of the second inner sliding surface 147, and the second portion 155b of the outer sliding surface 155 are inclined with respect to the longitudinal direction of the guide rail 50. Therefore, when the first inner sliding shaft 222, the second inner sliding shaft 223, and the outer sliding shaft 224 slide on the second portion 146b of the first inner sliding surface 146, the second portion 147b of the second inner sliding surface 147, and the second portion 155b of the outer sliding surface 155, respectively, the posture of the rear link 220 changes. Specifically, the rear end portion of the rear link 220 is lifted with respect to a front end portion of the rear link 220. In other words, the rear connecting shaft 242 is lifted. In this way, the rear link 220 is displaced from the storage position of being accommodated in the guide rail 50 toward the upright position of rising with respect to the guide rail 50. Further, in the up-down direction, the first inner sliding shaft 222 moves upward, while the second inner sliding shaft 223 moves downward. At this time, the rear link 220 rotates about an axis passing in the width direction between an axis of the first inner sliding shaft 222 and an axis of the second inner sliding shaft 223. Further, when the outer sliding shaft 224 slides on the second portion 155b of the outer sliding surface 155, a state is switched from a state in which the first flat surface 224a slides on the second portion 155b to a state in which the second flat surface 224b slides on the second portion 155b.

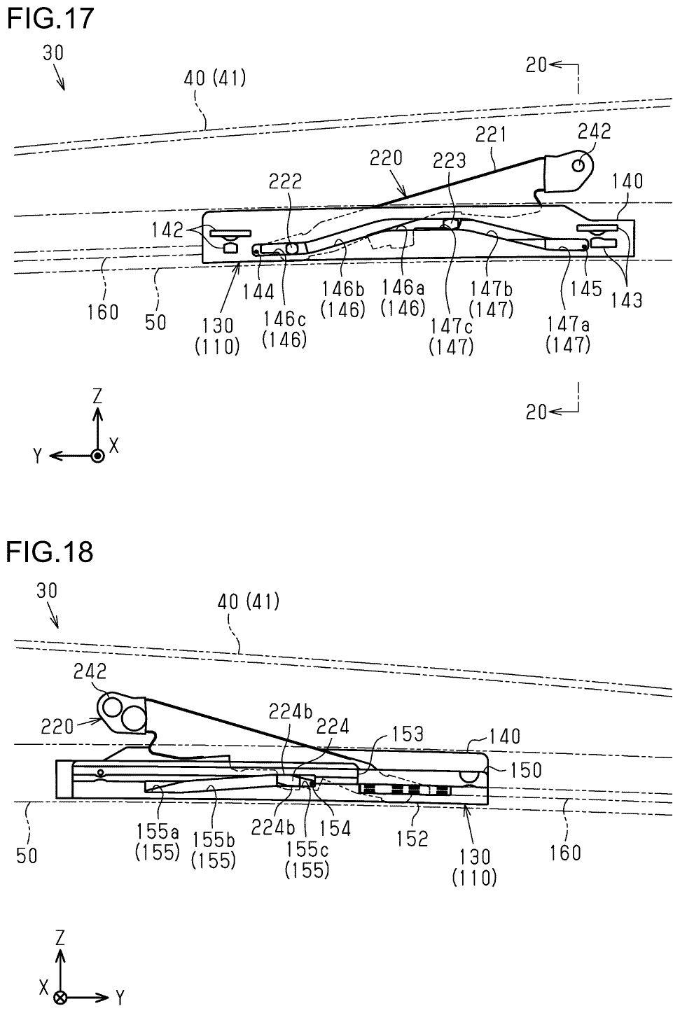

As illustrated in FIGS. 17 and 18, the third portion 146c of the first inner sliding surface 146, the third portion 147c of the second inner sliding surface 147, and the third portion 155c of the outer sliding surface 155 extend in the longitudinal direction of the guide rail 50. Therefore, when the first inner sliding shaft 222, the second inner sliding shaft 223, and the outer sliding shaft 224 slide on the third portion 146c of the first inner sliding surface 146, the third portion 147c of the second inner sliding surface 147, and the third portion 155c of the outer sliding surface 155, respectively, the posture of the rear link 220 does not change much. Further, when the outer sliding shaft 224 slides on the third portion 155c of the outer sliding surface 155, the second flat surface 224b slides on the third portion 155c.

As illustrated in FIGS. 17 and 18, when the drive shoe 110 moves to the tilt-up corresponding position, the first inner sliding shaft 222 of the rear link 220 moves to the vicinity of a front end of the first inner sliding groove 144 of the rear shoe 130. Whereas, the second inner sliding shaft 223 of the rear link 220 moves to the vicinity of a front end of the second inner sliding groove 145 of the rear shoe 130. In this way, the rear link 220 is arranged in an upright position of rising most with respect to the guide rail 50. As illustrated in FIG. 17, when the rear link 220 is arranged in the upright position, the first inner sliding shaft 222 is located upward of the second inner sliding shaft 223. Although not illustrated, when the rear link 220 is arranged in the upright position, the front end portion of the rear link 220 is accommodated in the retraction hole 132 of the rear shoe 130. Therefore, when the rear link 220 is arranged in the upright position, the rear end portion of the rear link 220 is greatly lifted while avoiding interference between the rear link 220 and the bottom wall 131 of the rear shoe 130.

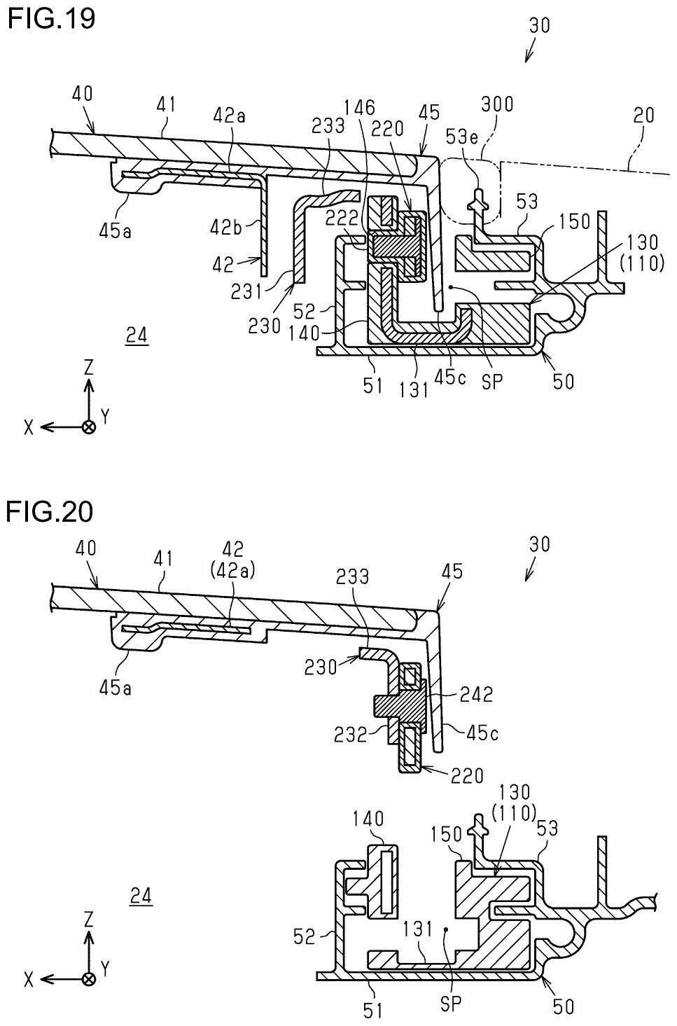

As illustrated in FIGS. 13 and 19, under a situation where the movable panel 40 is arranged in the fully closed position, the side lip 45c of the movable panel 40 is accommodated in the lip accommodation space SP between the outer wall 150 of the rear shoe 130 and the rear link 220.

### Effects of Present Embodiment

(1) In the sunroof device 30, the movable panel 40 has the side lips 45c on both sides in the width direction. Therefore, the sunroof device 30 can suppress wind noise generated on both sides of the movable panel 40 when the vehicle 10 travels in a state where the movable panel 40 is arranged in the tilt-up position. Furthermore, in the sunroof device 30, when the rear shoe 130 moves forward or rearward, power is transmitted from the rear shoe 130 to the rear link 220. At this time, power is transmitted to the rear link 220 from both the inner wall 140 and the outer wall 150 of the rear shoe 130. Specifically, inside the rear link 220, the first inner sliding shaft 222 and the second inner sliding shaft 223 slide on the first inner sliding surface 146 and the second inner sliding surface 147, respectively, and the outer sliding shaft 224 slides on the outer sliding surface 155 outside the rear link 220. That is, the rear shoe 130 has portions for transmitting power to the rear link 220 not only on one side in the width direction but also on both sides in the width direction. Therefore, the sunroof device 30 can increase rigidity against a load in the up-down direction acting on the movable panel 40. In this way, the sunroof device 30 can improve usability of the device in that generation of wind noise can be suppressed and the rigidity of the device can be increased during high-speed traveling of the vehicle 10.

(2) In the rear shoe 130, a height of the outer wall 150 is lower than a height of the inner wall 140. Therefore, as illustrated in FIG. 19, the sunroof device 30 can cause the fifth outer guide wall 53e of the guide rail 50 to hold a weather strip 300 that closes a gap between the vehicle body 20 and the movable panel 40, without interfering with the inner wall 140 of the rear shoe 130. In addition, the sunroof device 30 can increase a degree of freedom of the roof design of the vehicle 10.

(3) The rear link 220 has the first inner sliding shaft 222 and the second inner sliding shaft 223, and the rear shoe 130 has the first inner sliding surface 146 and the second inner sliding surface 147. Therefore, the sunroof device 30 can increase rigidity against a load acting on the movable panel 40 as compared with a comparative example in which the rear link 220 has a single inner sliding shaft and the rear shoe 130 has a single inner sliding surface. Further, considering another comparative example having two outer sliding shafts 224 in the rear link 220, in the comparative example, there is a possibility that the lip accommodation space SP may be narrowed by the two outer sliding shafts 224. In this regard, since the rear link 220 includes the first inner sliding shaft 222 and the second inner sliding shaft 223 as the two inner sliding shafts, narrowing of the lip accommodation space SP by the two inner sliding shafts is suppressed.

Further, a gap between the rear link 220 and the outer wall 150 of the rear shoe 130 is larger than a gap between the rear link 220 and the inner wall 140 of the rear shoe 130. In this regard, the sunroof device 30 can suppress narrowing of the lip accommodation space SP in the width direction.

(4) For example, when the rear link 220 is displaced between the storage position and the upright position by rotating about the axis of the first inner sliding shaft 222, a force transmitted from the rear shoe 130 to the first inner sliding shaft 222 does not contribute to a torque for rotating the rear link 220. Similarly, when the rear link 220 rotates about the axis of the second inner sliding shaft 223, a force transmitted from the rear shoe 130 to the second inner sliding shaft 223 does not contribute to a torque for rotating the rear link 220. Whereas, in the present embodiment, when the rear link 220 is displaced between the storage position and the upright position, the first inner sliding shaft 222 and the second inner sliding shaft 223 of the rear link 220 move in different directions in the up-down direction, on the basis of a force transmitted from the rear shoe 130. That is, both the force transmitted from the rear shoe 130 to the first inner sliding shaft 222 and the force transmitted from the rear shoe 130 to the second inner sliding shaft 223 contribute to the torque for rotating the rear link 220. Therefore, the sunroof device 30 can increase power transmission efficiency from the rear shoe 130 to the rear link 220.

(5) As illustrated in FIG. 20, when the movable panel 40 is arranged in the tilt-up position or the fully open position, the rear end portion of the rear link 220 is located upward of an upper end of the guide rail 50. However, when the sunroof device 30 is viewed from the width direction, a connection portion between the rear link 220 and the support bracket 230 is hidden by the side lip 45c of the movable panel 40. In other words, the rear connecting shaft 242 connecting the rear link 220 and the support bracket 230 is hidden by the side lip 45c of the movable panel 40. In this way, the sunroof device 30 can improve an aesthetic appearance when the sunroof device 30 is viewed from the width direction, by increasing a length of the side lip 45c of the movable panel 40.

(6) The outer sliding shaft 224 of the rear link 220 has two first flat surfaces 224a that are in surface contact with the outer sliding surface 155 of the rear shoe 130 when the movable panel 40 is arranged in the fully closed position, the tilt-up position, the fully open position, and the like. Furthermore, the outer sliding shaft 224 of the rear link 220 has two second flat surfaces 224b that are in surface contact with the outer sliding surface 155 of the rear shoe 130 during a tilt-up operation of the movable panel 40. Therefore, in the sunroof device 30, a contact area between the outer sliding shaft 224 of the rear link 220 and the outer sliding surface 155 of the rear shoe 130 can be increased. As a result, regardless of the position of the movable panel 40, when a load acts on the movable panel 40, the sunroof device 30 can suppress an increase in stress generated at a contact portion between the outer sliding shaft 224 of the rear link 220 and the outer sliding surface 155 of the rear shoe 130.

(7) In the rear link 220, if the outer sliding shaft 224 is located forward of the first inner sliding shaft 222 or the outer sliding shaft 224 is located rearward of the second inner sliding shaft 223, a size of the rear link 220 tends to be large. In this regard, in the rear link 220 of the sunroof device 30, the outer sliding shaft 224 is located rearward from the first inner sliding shaft 222 and forward of the second inner sliding shaft 223. Therefore, the sunroof device 30 can suppress an increase in size of the rear link 220.

(8) For example, when the bottom wall 131 of the rear shoe 130 does not have the retraction hole 132, it is necessary to configure such that the front end portion of the rear link 220 arranged in the upright position does not interfere with the bottom wall 131. In this case, when the rear link 220 is displaced from the storage position to the upright position, a lifted amount of the rear end portion of the rear link 220 is reduced. That is, the lifted amount of the rear end portion of the movable panel 40 when the movable panel 40 is displaced from the fully closed position to the tilt-up position is reduced. Whereas, the bottom wall 131 of the rear shoe 130 has the retraction hole 132 that accommodates the front end portion of the rear link 220 arranged in the upright position. Therefore, the sunroof device 30 can suppress a decrease in the lifted amount of the rear end portion of the movable panel 40 when the movable panel 40 is displaced from the fully closed position to the tilt-up position.

### Modifications

The present embodiment can be modified as follows. The present embodiment and the following modification examples can be implemented in combination with each other within a range not technically contradictory.
A length and a shape of the side lip 45c of the movable panel 40 can be changed as appropriate. For example, when the sunroof device 30 is viewed from the width direction, the side lip 45c of the movable panel 40 may be cut out so that the rear connecting shaft 242 can be exposed.
In the drive shoe 110, the power transmission member 160 may be a check rod capable of switching a transmission state of power from the front shoe 120 to the rear shoe 130. In this case, the check rod preferably permits transmission of power from the front shoe 120 to the rear shoe 130 when the drive shoe 110 moves between the full-close corresponding position and the tilt-up corresponding position. Whereas, the check rod preferably inhibits transmission of power from the front shoe 120 to the rear shoe 130 when the drive shoe 110 moves between the tilt-up corresponding position and the full-open corresponding position.
In the above embodiment, the rear link 220 is displaced to the upright position when the rear shoe 130 moves rearward, and is displaced to the storage position when the rear shoe 130 moves forward. Whereas, in the rear shoe 130, by changing the inclination of the first inner sliding groove 144 and the second inner sliding groove 145, the rear link 220 may be displaced to the storage position when the rear shoe 130 moves rearward, and the rear link 220 may be displaced to the upright position when the rear shoe 130 moves forward.
A height of the inner wall 140 of the rear shoe 130 and a height of the outer wall 150 of the rear shoe 130 may be equal. In this case, the inner wall 140 of the rear shoe 130 and the outer wall 150 of the rear shoe 130 may have symmetrical shapes in the width direction.
The inner wall 140 of the rear shoe 130 may have a configuration corresponding to the first inner sliding shaft 222 and the second inner sliding shaft 223. In this case, the rear link 220 preferably has a configuration corresponding to the first inner sliding groove 144 and the second inner sliding groove 145. Similarly, the outer wall 150 of the rear shoe 130 may have a configuration corresponding to the outer sliding shaft 224. In this case, the rear link 220 preferably has a configuration corresponding to the outer sliding groove 154.
A transmission mode of power between the rear link 220 and the inner wall 140 and the outer wall 150 of the rear shoe 130 can be appropriately changed. That is, the power transmission from the rear shoe 130 to the rear link 220 is not necessarily power transmission through the sliding shaft and the sliding surface.
In the rear shoe 130, the first inner sliding groove 144 may extend along the longitudinal direction of the guide rail 50, and the second inner sliding groove 145 may be inclined with respect to the longitudinal direction of the guide rail 50. In this case, the rear link 220 may be configured to move between the storage position and the upright position when the first inner sliding shaft 222 and the second inner sliding shaft 223 of the rear link 220 move along the first inner sliding groove 144 and the second inner sliding groove 145 of the rear shoe 130, respectively. In this case, a rotation axis of the rear link 220 is a rotation axis of the first inner sliding shaft 222.
It suffices that the rear link 220 includes at least one of the first inner sliding shaft 222 or the second inner sliding shaft 223. In this case, out of the first inner sliding groove 144 and the second inner sliding groove 145, it suffices that the rear shoe 130 includes the inner sliding groove alone corresponding to the inner sliding shaft included in the rear link 220.
In the rear link 220, a cross-sectional shape orthogonal to a protruding direction of the outer sliding groove 154 may be circular. This similarly applies to the first inner sliding shaft 222 and the second inner sliding shaft 223.
The rear link 220 may include one inner sliding shaft and one outer sliding shaft 224 on the same axis. In this case, the rear link 220 may be configured to rotate between the storage position and the upright position by rotating about the axis of these sliding shafts.
When the rear link 220 is displaced from the storage position to the upright position, the front end portion may be lifted with respect to the rear end portion. In this case, the front end portion of the rear link 220 is preferably connected to the support bracket 230.
The rear link 220 may include one inner sliding shaft and two outer sliding shafts 224.
A configuration corresponding to the lip accommodation space SP between the rear link 220 and the rear shoe 130 may also be provided between the front link 210 and the front shoe 120.
The panel bracket 42 of the movable panel 40 may be configured integrally with the support bracket 230. In this case, an integral body of the panel bracket 42 and the support bracket 230 in the above embodiment corresponds to the “support bracket”.

### Summary of Present Embodiment

(1) A sunroof device includes: a movable panel that operates between a fully closed position in which a roof opening of a vehicle is fully closed and a tilt-up position in which a rear end portion is lifted from the fully closed position; a guide rail having a longitudinal direction in a front-rear direction; a support bracket that supports the movable panel and has a longitudinal direction in the front-rear direction; a rear link that is displaced between a storage position and an upright position in a state of supporting a portion of the support bracket closer to a rear end than a front end of the support bracket; and a drive shoe that moves in the front-rear direction along the guide rail to drive the rear link, in which the movable panel includes: a panel body that covers the roof opening; and side lips extending downward from both ends in a width direction of the panel body, the rear link displaces the movable panel to the tilt-up position by being displaced to the upright position along with movement of the drive shoe to one of forward or rearward, the rear link displaces the movable panel to the fully closed position by being displaced to the storage position along with movement of the drive shoe to another one of forward or rearward, the drive shoe includes a bottom wall, an inner wall extending upward from the bottom wall, and an outer wall extending upward from the bottom wall on an outer side of the inner wall in the width direction, the drive shoe transmits power for displacing the rear link to the rear link via both the inner wall and the outer wall, the rear link is disposed between the inner wall and the outer wall of the drive shoe in the width direction, and a lip accommodation space that allows the side lips of the movable panel to be accommodated is present between the rear link and the outer wall.

That is, a sunroof device includes: a movable panel that operates between a fully closed position in which a roof opening of a vehicle is fully closed and a tilt-up position in which a rear end portion is lifted from the fully closed position; a guide rail having a longitudinal direction in a front-rear direction; a support bracket that supports the movable panel and has a longitudinal direction in the front-rear direction; a rear link that is displaced between a storage position and an upright position in a state of supporting a portion of the support bracket closer to a rear end than a front end of the support bracket; and a drive shoe that moves in the front-rear direction along the guide rail to drive the rear link. The movable panel includes a panel body that covers the roof opening, and side lips extending downward from both ends in a width direction of the panel body. The rear link displaces the movable panel to the tilt-up position by being displaced to the upright position along with movement of the drive shoe to one of forward or rearward, and the rear link displaces the movable panel to the fully closed position by being displaced to the storage position along with movement of the drive shoe to another one of forward or rearward. The drive shoe includes a bottom wall, an inner wall extending upward from the bottom wall, and an outer wall extending upward from the bottom wall on an outer side of the inner wall in the width direction, and the drive shoe transmits power for displacing the rear link to the rear link via both the inner wall and the outer wall. In the width direction, the rear link is disposed between the inner wall and the outer wall of the drive shoe, and a lip accommodation space that allows the side lips of the movable panel to be accommodated is present between the rear link and the outer wall.

In the sunroof device, the movable panel has side lips on both sides in the width direction. Therefore, the sunroof device can suppress wind noise generated on both sides of the movable panel when the vehicle travels in a state where the movable panel is arranged in the tilt-up position. Further, in the sunroof device, when the drive shoe moves in the front-rear direction, power is transmitted from the drive shoe to the rear link. At this time, power is transmitted to the rear link from both the inner wall and the outer wall of the drive shoe. That is, the drive shoe does not transmit power to the rear link on one side alone in the width direction, but transmits power to the rear link on both sides in the width direction. Therefore, the sunroof device can increase rigidity against a load acting on the movable panel. In this way, the sunroof device can improve usability of the device in that generation of wind noise can be suppressed and the rigidity of the device can be increased during high-speed traveling of the vehicle.

That is, the sunroof device can improve usability of a vehicle during high-speed traveling.

(2) In the sunroof device, a height of the outer wall of the drive shoe is preferably lower than a height of the inner wall of the drive shoe.

That is, in the sunroof device, a height of the outer wall of the drive shoe is lower than a height of the inner wall of the drive shoe.

The sunroof device can ensure a space for arranging other components of the sunroof device, such as a weather strip above a movement range of the inner wall of the drive shoe when the drive shoe moves in the front-rear direction.

(3) In the sunroof device described above, it is preferable that the rear link includes an inner sliding shaft having an axial direction in a width direction and an outer sliding shaft having an axial direction in the width direction, the outer wall of the drive shoe has an outer sliding surface that transmits power to the rear link by sliding on the outer sliding shaft when the drive shoe moves in the front-rear direction, the inner wall of the drive shoe has an inner sliding surface that transmits power to the rear link by sliding on the inner sliding shaft when the drive shoe moves in the front-rear direction, the inner sliding shaft includes a first inner sliding shaft and a second inner sliding shaft located with an interval from the first inner sliding shaft, the inner sliding surface includes a first inner sliding surface that slides on the first inner sliding shaft and a second inner sliding surface that slides on the second inner sliding shaft, and a gap between the rear link and the outer wall is larger than a gap between the rear link and the inner wall.

That is, in the sunroof device, the rear link includes an inner sliding shaft having an axial direction in the width direction, and an outer sliding shaft having an axial direction in the width direction, the outer wall of the drive shoe has an outer sliding surface that transmits power to the rear link by sliding on the outer sliding shaft when the drive shoe moves in the front-rear direction, the inner wall of the drive shoe has an inner sliding surface that transmits power to the rear link by sliding on the inner sliding shaft when the drive shoe moves in the front-rear direction, the inner sliding shaft includes a first inner sliding shaft and a second inner sliding shaft located with an interval from the first inner sliding shaft, the inner sliding surface includes a first inner sliding surface that slides on the first inner sliding shaft and a second inner sliding surface that slides on the second inner sliding shaft, and a gap between the rear link and the outer wall is larger than a gap between the rear link and the inner wall.

In the sunroof device, the inner sliding shaft has two sliding shafts, and the inner sliding surface has two sliding surfaces. Therefore, the sunroof device can further increase rigidity against a load acting on the movable panel. In addition, in the rear link, in a case where the outer sliding shaft has two sliding shafts, there is a possibility that the lip accommodation space is narrowed by the two sliding shafts. Whereas, in the rear link having the above configuration, the inner sliding shaft has two sliding shafts. Therefore, the sunroof device can suppress narrowing of the lip accommodation space. In addition, the sunroof device can further suppress narrowing of the lip accommodation space in that a gap between the rear link and the outer wall of the drive shoe is larger than a gap between the rear link and the inner wall of the drive shoe.

(4) In the sunroof device described above, it is preferable that, when the rear link is displaced from the storage position to the upright position, the first inner sliding shaft of the rear link is lowered and the second inner sliding shaft of the rear link is lifted by the rear link sliding on the drive shoe, and when the rear link is displaced from the upright position to the storage position, the first inner sliding shaft of the rear link is lifted and the second inner sliding shaft of the rear link is lowered by the rear link sliding on the drive shoe.

That is, in the sunroof device, when the rear link is displaced from the storage position to the upright position, the first inner sliding shaft of the rear link is lowered and the second inner sliding shaft of the rear link is lifted by the rear link sliding on the drive shoe, and when the rear link is displaced from the upright position to the storage position, the first inner sliding shaft of the rear link is lifted and the second inner sliding shaft of the rear link is lowered by the rear link sliding on the drive shoe.

For example, when the rear link is displaced between the storage position and the upright position by rotating about an axis of the first inner sliding shaft, a force transmitted from the drive shoe to the first inner sliding shaft does not contribute to a torque for rotating the rear link. Similarly, when the rear link rotates about an axis of the second inner sliding shaft, a force transmitted from the drive shoe to the second inner sliding shaft does not contribute to a torque for rotating the rear link. Whereas, in the sunroof device having the above configuration, when the rear link is displaced between the storage position and the upright position, the first inner sliding shaft and the second inner sliding shaft of the rear link move in different directions in the up-down direction, on the basis of a force transmitted from the drive shoe. That is, both the force transmitted from the drive shoe to the first inner sliding shaft and the force transmitted from the drive shoe to the second inner sliding shaft contribute to the torque for rotating the rear link. Therefore, the sunroof device can increase power transmission efficiency from the drive shoe to the rear link.

Preferably, the sunroof device includes a rear connecting shaft that rotatably connects the support bracket and the rear link about an axis extending in the width direction, and the rear connecting shaft is covered with the side lips of the movable panel when the movable panel is viewed from an outer side in the width direction.

The sunroof device can improve an aesthetic appearance when the sunroof device is viewed from the width direction, by increasing a length of the side lips of the movable panel.

In the sunroof device, a portion of the outer sliding shaft that slides on the outer sliding surface preferably has a planar shape.

In the sunroof device, a contact area between the outer sliding shaft of the rear link and the outer sliding surface of the drive shoe can be increased. As a result, when a load acts on the movable panel, the sunroof device can suppress an increase in stress generated at a contact portion between the outer sliding shaft of the rear link and the outer sliding surface of the drive shoe.

In the front-rear direction, the outer sliding shaft is preferably located between the first inner sliding shaft and the second inner sliding shaft.

In the rear link, if the outer sliding shaft is located forward of the first inner sliding shaft or the outer sliding shaft is located rearward of the second inner sliding shaft, a size of the rear link tends to be large. In this regard, in the rear link having the above configuration, the outer sliding shaft is located rearward from the first inner sliding shaft and forward of the second inner sliding shaft. Therefore, the sunroof device can suppress an increase in size of the rear link.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A sunroof device comprising:
a movable panel that operates between a fully closed position in which a roof opening of a vehicle is fully closed and a tilt-up position in which a rear end portion is lifted from the fully closed position;
a guide rail having a longitudinal direction in a front-rear direction;
a support bracket that supports the movable panel and has a longitudinal direction in the front-rear direction;
a rear link that is displaced between a storage position and an upright position in a state of supporting a portion of the support bracket closer to a rear end than a front end of the support bracket; and
a drive shoe that moves in the front-rear direction along the guide rail to drive the rear link,
wherein
the movable panel includes a panel body that covers the roof opening, and side lips extending downward from both ends in a width direction of the panel body,
the rear link displaces the movable panel to the tilt-up position by being displaced to the upright position along with movement of the drive shoe to one of forward or rearward, and the rear link displaces the movable panel to the fully closed position by being displaced to the storage position along with movement of the drive shoe to another one of forward or rearward,
the drive shoe includes a bottom wall, an inner wall extending upward from the bottom wall, and an outer wall extending upward from the bottom wall on an outer side of the inner wall in the width direction, and the drive shoe transmits power for displacing the rear link to the rear link via both the inner wall and the outer wall, and
in the width direction, the rear link is disposed between the inner wall and the outer wall of the drive shoe, and a lip accommodation space that allows the side lips of the movable panel to be accommodated is present between the rear link and the outer wall.

2. The sunroof device according to claim 1, wherein
a height of the outer wall of the drive shoe is lower than a height of the inner wall of the drive shoe.

3. The sunroof device according to claim 2, wherein
the rear link includes an inner sliding shaft having an axial direction in the width direction, and an outer sliding shaft having an axial direction in the width direction,
the outer wall of the drive shoe has an outer sliding surface that transmits power to the rear link by sliding on the outer sliding shaft when the drive shoe moves in the front-rear direction,
the inner wall of the drive shoe has an inner sliding surface that transmits power to the rear link by sliding on the inner sliding shaft when the drive shoe moves in the front-rear direction,
the inner sliding shaft includes a first inner sliding shaft and a second inner sliding shaft located with an interval from the first inner sliding shaft,
the inner sliding surface includes a first inner sliding surface that slides on the first inner sliding shaft and a second inner sliding surface that slides on the second inner sliding shaft, and
a gap between the rear link and the outer wall is larger than a gap between the rear link and the inner wall.

4. The sunroof device according to claim 3, wherein
when the rear link is displaced from the storage position to the upright position, the first inner sliding shaft of the rear link is lowered and the second inner sliding shaft of the rear link is lifted by the rear link sliding on the drive shoe, and
when the rear link is displaced from the upright position to the storage position, the first inner sliding shaft of the rear link is lifted and the second inner sliding shaft of the rear link is lowered by the rear link sliding on the drive shoe.

5. The sunroof device according to claim 1, wherein
the rear link includes an inner sliding shaft having an axial direction in the width direction, and an outer sliding shaft having an axial direction in the width direction,
the outer wall of the drive shoe has an outer sliding surface that transmits power to the rear link by sliding on the outer sliding shaft when the drive shoe moves in the front-rear direction,
the inner wall of the drive shoe has an inner sliding surface that transmits power to the rear link by sliding on the inner sliding shaft when the drive shoe moves in the front-rear direction,
the inner sliding shaft includes a first inner sliding shaft and a second inner sliding shaft located with an interval from the first inner sliding shaft,
the inner sliding surface includes a first inner sliding surface that slides on the first inner sliding shaft and a second inner sliding surface that slides on the second inner sliding shaft, and
a gap between the rear link and the outer wall is larger than a gap between the rear link and the inner wall.

5. unroof device according to claim 5, wherein
when the rear link is displaced from the storage position to the upright position, the first inner sliding shaft of the rear link is lowered and the second inner sliding shaft of the rear link is lifted by the rear link sliding on the drive shoe, and
when the rear link is displaced from the upright position to the storage position, the first inner sliding shaft of the rear link is lifted and the second inner sliding shaft of the rear link is lowered by the rear link sliding on the drive shoe.
